(19) United States
(12) Patent Application Publication
(10) Pub. No.: US 2019/0065405 A1
(43) Pub. Date: Feb. 28, 2019

(54) SECURITY AWARE NON-SPECULATIVE MEMORY

(71) Applicant: QUALCOMM Incorporated, San Diego, CA (US)

(72) Inventors: Kevin Christopher GOTZE, Hillsboro, OR (US); Can ACAR, San Diego, CA (US); David HARTLEY, Berlin (DE); Qing LI, San Diego, CA (US); Daniel GODAS-LOPEZ, San Diego, CA (US)

(21) Appl. No.: 16/002,872

(22) Filed: Jun. 7, 2018

Related U.S. Application Data
(60) Provisional application No. 62/551,744, filed on Aug. 29, 2017.

(51) Int. Cl. G06F 12/14; G06F 21/78; G06F 3/06

(52) U.S. Cl. CPC G06F 12/1408; G06F 3/0623; G06F 21/78

(57) ABSTRACT

Several features pertain to computing systems equipped to perform speculative processing and configured to access device memory (e.g. non-speculative or unspeculatable memory) and non-device memory (e.g. speculative or speculatable memory). Malicious attacks may seek to obtain sensitive information from such systems by exploiting speculative code execution. Herein, techniques are described whereby sensitive data is protected from such attacks by placing the data in a page of memory not ordinarily used as device memory, and then designating or marking the page as device memory (e.g. marking the page as unspeculatable). By designating the page as unspeculatable device memory, the processor does not speculatively access the sensitive information (e.g. speculation stops once a branch is invoked that would access the page) and so certain types of attacks can be mitigated. In some examples, additional malicious attack defenses or mitigations are performed such as address space un-mapping, address space layout randomization, or anti-replay-protection.

### CLAIM OF PRIORITY UNDER 35 U.S.C. § 119

The present Application for Patent claims priority to Provisional Application No. 62/551,744 entitled “SECURITY AWARE NON-SPECULATIVE MEMORY” filed Aug. 29, 2017, which is assigned to the assignee hereof and hereby expressly incorporated by reference herein.

### BACKGROUND

### Field of the Disclosure

Various features relate to computing systems and more particularly to the preventing access to secure or sensitive resources or content.

### Description of Related Art

State-of-the-art central computing systems (CPUs) often employ speculative processing and/or branch prediction to enhance performance A possible security vulnerability may arise whereby an attacker exploits speculative access to data prior to the CPU confirming the correctness of that access. The attack may include a side-channel attack (such as a cache side channel attack or branch predictor side channel attack). This may have adverse consequences for the security of sensitive data (e.g. cryptographic keys stored in memory) for which confidentiality must be maintained from attackers in peer or lower privilege levels. One example of such a vulnerability is the so-called spectre vulnerability. Another example is the so-called meltdown vulnerability, which especially affects Intel x86 microprocessors, IBM POWER processors, and some ARM-based microprocessors. (Intel, IBM and ARM are trademarks of their respective companies.)

It would be desirable to provide mitigations to address these or other issues.

### SUMMARY

In one aspect, a method is provided for use by a computing system equipped to access device memory (sometimes called non-speculative or unspeculatable memory) and non-device memory (sometimes called speculative or speculatable memory). The method includes: identifying sensitive information to protect; designating a portion of non-device memory as device memory; and storing the sensitive information in the portion of non-device memory designated as device memory.

In another aspect, a computing system includes: a memory including a portion that is non-device memory; and a processor configured to identify sensitive information to protect, designate a portion of the non-device memory as device memory, and store the sensitive information in the portion of non-device memory designated as device memory.

In yet another aspect, an apparatus comprises: means for identifying sensitive information to protect; means for designating a portion of non-device memory as device memory; and means for storing the sensitive information in the portion of non-device memory designated as device memory.

In still yet another aspect, a non-transitory machine-readable storage medium for use with a computing system is provided, the machine-readable storage medium having one or more instructions which when executed by at least one processing circuit of the computing system causes the at least one processing circuit to: identify sensitive information to protect; designate a portion of non-device memory as device memory; and store the sensitive information in the portion of non-device memory designated as device memory.

### BRIEF DESCRIPTION OF THE DRAWINGS

FIG. 1 is a block diagram illustrating exemplary components of a computing and/or processing system having components for designating portions of memory containing sensitive data as device memory to prevent speculative access to the data.

FIG. 2 is a timing diagram summarizing exemplary procedures for use by a computing system such as the system of FIG. 1.

FIG. 3 is a flow diagram summarizing additional exemplary procedures for use by a computing system such as the system of FIG. 1.

FIG. 4 is a block diagram illustrating exemplary components of a computing system having a software interface to facilitate designating portions of memory containing sensitive data as device memory to prevent speculative access.

FIG. 5 is a flow diagram summarizing exemplary procedures for use by a computing system such as the system of FIG. 4.

FIG. 6 is a block diagram illustrating exemplary components of an alternative computing system also having a software interface to facilitate designating portions of memory containing sensitive data as device memory to prevent speculative access.

FIG. 7 is a flow diagram summarizing exemplary procedures for use by a computing system such as the system of FIG. 6.

FIG. 8 is a schematic block diagram illustrating an exemplary computing system equipped with a RISC processor with components for designating portions of memory containing sensitive data as device memory to prevent speculative access to the data.

FIG. 9 illustrates an exemplary system-on-a-chip (SoC) wherein the SoC includes components for designating portions of memory containing sensitive data as device memory to prevent speculative access to the data.

FIG. 10 is a block diagram illustrating another example of a hardware implementation for an apparatus employing a processing system that may exploit the systems, methods and apparatus described herein.

FIG. 11 is a high level flow diagram summarizing exemplary procedures for designating portions of memory containing sensitive information as device memory.

FIG. 12 is a high level block diagram illustrating exemplary components of a processor configured to designate portions of memory containing sensitive information as device memory.

FIG. 13 is a block diagram illustrating additional exemplary components of the processor of FIG. 12.

FIG. 14 is a flow diagram summarizing additional exemplary procedures for protecting sensitive information.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview

Several features pertain to methods and apparatus for use with computing systems equipped perform speculative processing and configured to access device memory (sometimes called non-speculative, nonspeculatable, or unspeculatable memory, e.g. memory that speculative processing components are blocked from accessing) and non-device memory (sometimes called speculative or speculatable memory, e.g. memory that speculative processing components are not blocked from accessing). In several of the examples described herein, the computing system includes a processing system equipped for speculative processing. In some examples, the device memory (e.g. the non-speculative or unspeculatable memory) is associated with an external peripheral device. Speculative processing is not permitted using that memory since it affects a peripheral device. However, the non-device memory of the system can be used by the processor for speculative processing. As noted above, problems can arise in such systems as a result of malicious attacks that seek to obtain sensitive or secure information by exploiting the speculative execution. Attackers using software running in a low privilege mode can induce the processor to follow speculative processing paths or branches in a higher privileged mode that accesses sensitive memory. Even if the processor subsequently flushes the results of the speculative processing, the attacker may exploit side-channel analysis to reveal bits stored in the sensitive memory to thereby reveal cryptographic keys or the like. In this regard, at least some processors have been designed under the assumption that the results of speculative processing will not be vulnerable to attackers so long as the results are flushed. An attacker can exploit the vulnerability unless steps are takes to mitigate or eliminated the vulnerability.

Still further, modern central processing units (CPUs) are often configured to explicitly designate portions of memory as “device memory,” while other portions might be regarded as “non-device memory.” Within such CPUs, speculative processing is blocked from accessing device memory (e.g. non-speculative/unspeculatable/non-speculatable memory) since access based on incorrect speculation may adversely impact data stored in an external device (even if those speculative results are later flushed by the processor). And so the processor simply delays issuing loads or stores to “device memory” whenever a branch is speculatively reached that would access device memory until that branch's direction is resolved non-speculatively. This prevents any such adverse effects since the processor is forbidden to speculatively access device memory. Speculative processing is instead restricted to accessing only non-device memory (e.g. only speculative/speculatable memory), which may include SRAM formed on a System-on-a-Chip (SoC) device that includes the processor, but may also include external dynamic RAM (DRAM) that is off-chip.

Herein, techniques are described whereby sensitive data is protected from the aforementioned attacks by placing the sensitive data in a page of memory that is not ordinarily used as device memory (such as a page of SRAM on a secure SoC), but then designating the page as device memory. By designating the page as device memory, the processor then does not speculatively access the sensitive information (e.g. speculation stops once a branch is invoked that would access the page) and so the types of attacks described above are mitigated.

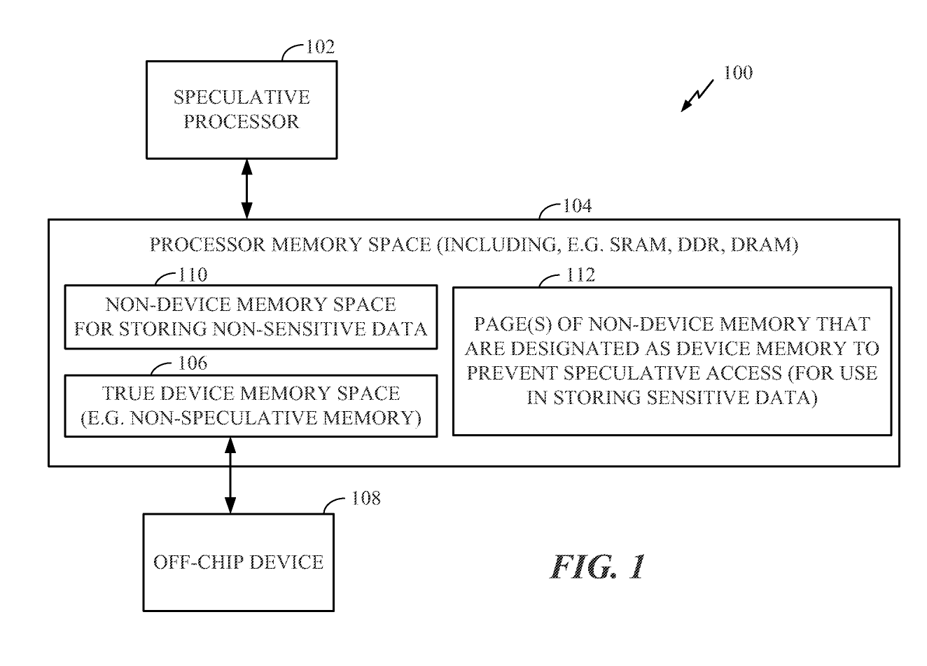

As shown in FIG. 1, an exemplary computing system 100 includes a speculative processor 102 and a memory space 104. The memory space includes a true device memory space (e.g. non-speculative/unspeculatable memory) 106 with which the processor can access an off-chip device 108. In many instances, at least some the device memory space 106 is within an off-chip memory components such as an off-chip DRAM. The memory space 104 also includes non-device memory space 110, which is used to stored non-sensitive information or data. In many instances, the non-device memory space 110 is within an on-chip memory component such as an on-chip SRAM. The memory space 104 also includes regions or page(s) 112 of non-device memory (e.g. on-chip SRAM) that are designated or “marked” as device memory (herein “device-marked memory”) to prevent speculative access and which are then used to store sensitive data.

Implementation details may vary from platform to platform, or from operating system (OS) to operating system (OS). By way of example, the OS may be equipped with tools for managing the device-marked memory and for advertising or exposing that memory to software applications. In some examples (described below), an application programming implementation (API) is provided to advertise and make available the pages or regions of device-marked memory to software applications. The software then accesses the device-marked memory via the API. Sensitive information to be protected may be so designated by software or by the OS and then stored in particular pages of device-marked memory (or in pools of pages of memory) so that secure and supervised software applications can conveniently access the sensitive information. Also, note that practical devices (and their associated memory) can be “off-chip” (e.g. servers where PCI cards are attached that include device memory) or “on-chip” (e.g. SOC devices where a Graphics or Audio IP is accessed through device memory). Normal memory is often stored off-chip (typically in DRAM) but can also be on-chip in a SRAM in some instances. This “normal” memory can be partitioned using the techniques described herein into two parts, a “protected section” that is treated as device memory (and hence unspeculatable) and a remaining section that is be treated as normal (e.g. speculatable).

In one particular example, the system of FIG. 1 operates to create a new “secret store” memory range (of one or several marked pages) that prevents speculation with all “high value” secrets placed in this range (e.g. asymmetric cryptographic keys, symmetric cryptographic keys, Root keys, Derived keys, Seeds, Passwords, Authentication values, etc.), to mitigate speculation-based attacks of secrets stored in memory. By placing or storing the secrets in an isolated area of memory that is designated as device memory, and hence not accessed via speculative operations or branches, the method isolates potentially negative performance impacts to just the specific data (and related software usages) without generally and significantly impacting overall system performance.

Particular examples of “device memory” are ARM V7 “Device” and “Strongly Ordered” memory types, ARM V8 “ignore,” and “nGnRnE.” It is noted that “ARM” is a trademark of ARM Holdings or its affiliates. Within ARM v8, nGnRnE is the most restrictive memory type, as it is nG (non-gathering), nR (non-reordering) and nE (non-early write acknowledgement). Gathering or non-gathering relates to whether multiple accesses can be merged into a single transaction for this memory region. In particular, if an address is marked as non-Gathering (nG), then the number and size of accesses performed to that location must exactly match the number and size of explicit accesses in the code. If an address is marked as Gathering (G), the processor can, for example, merge two byte writes into a single halfword write. Reordering (R or nR) relates to whether accesses to the same device can be reordered with respect to each other. For example, if the address is marked as nR, then accesses within the same block always appear on the bus in program order. If the size of the block is large, it might span several table entries. In this case, the ordering rule is observed with respect to any other accesses also marked as nR. Early Write Acknowledgement (E or nE) relates to whether an intermediate write buffer between the processor and the device (being accessed) is allowed to send an acknowledgement of a write completion. For example, if an address is marked as non-nE, then the write response must come from the peripheral. If the address is marked as E, then a buffer in the interconnect logic can signal write acceptance, before the write is actually received by an end device. This is essentially a message to the external memory system.

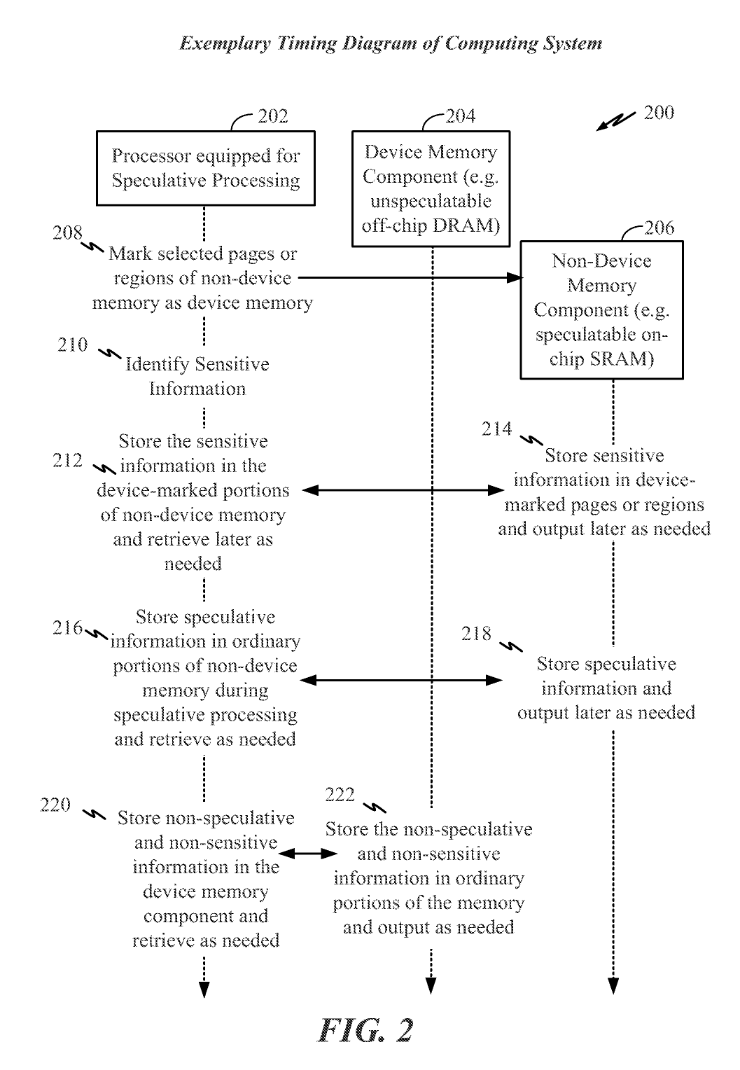

FIG. 2 provides a timing diagram 200 illustrating an exemplary sequence of operations performed by components of a computing system equipped to store sensitive information in device-marked pages of otherwise non-device memory (such as the system of FIG. 1). The figure illustrates operations performed by a processor equipped for speculative processing 202, a device memory component 204 (which may be off-chip unspeculatable SRAM) and a non-device memory component 206 (which may be on-chip speculatable SRAM).

Beginning at 208, the processor 202 marks selected pages or regions of non-device memory component 206 as device memory (e.g. non-speculative/unspeculatable memory). These pages or regions may be referred to as “device”-marked pages or regions. At 210, the processor 202 identifies sensitive information to be protected from speculative access (by potentially malicious software). The sensitive information may include passwords or the like. At 212, the processor 202 stores the sensitive information in the device-marked portions of non-device memory component 206 and later retrieves the information as needed. At 214, the non-device memory 206 stores the sensitive information received from the processor 202 in the device-marked pages or regions of its memory space and later outputs the information to the processor 202, as needed.

At 216, the processor 202 stores speculative information in ordinary portions of the non-device memory component 206 (e.g. non-device-marked portions) during speculative processing and later retrieves the speculative information as needed. At 214, the non-device memory component 206 stores the speculative information and outputs the information to the processor 202 as needed, such when speculative processing results are to be committed to a non-speculative state. At 220, the processor 202 stores non-speculative and non-sensitive information in the device memory component 204 and later retrieves the information as needed. At 222, the device memory component 204 stores the non-speculative and non-sensitive information within its memory space and later outputs the information to the processor as needed.

Thus, FIG. 2 illustrates one possible sequence of operations. It should be appreciated that some of the operations shown may be performed in a different order or may be performed concurrently. In use, the processor will store and retrieve information from various memory components at high speeds and in various ways in accordance with its programming. Also, as will be explained next, any sensitive information stored within the portions of non-device memory designated as device memory may be further protected via encryption or other procedures.

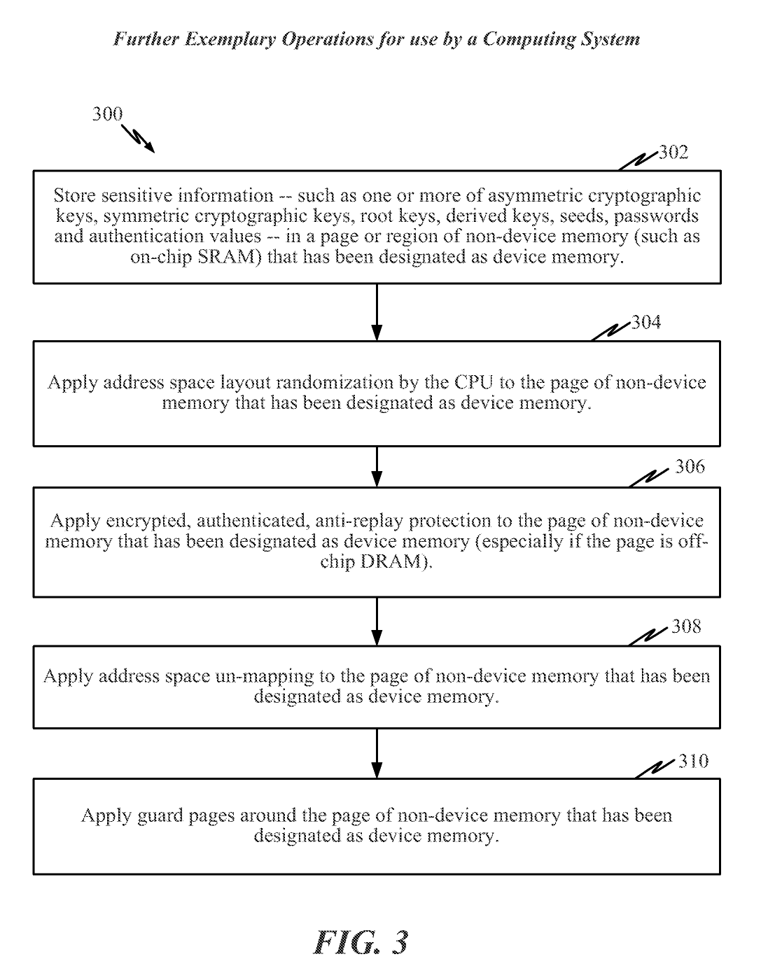

FIG. 3 illustrates additional techniques 300 that may be applied by a processor to provide additional protection and attack mitigation. At 302, a CPU or other processor stores sensitive information—such as one or more of asymmetric cryptographic keys, symmetric cryptographic keys, root keys, derived keys, seeds, passwords and authentication values—in a page or region of non-device memory such as SRAM that has been designated as device memory. Note that by using SRAM for these pages, the sensitive data is not sent off the SOC (e.g. to a DDR) where it might be more vulnerable.

At 304, address space layout randomization may be applied by the CPU to the pages of non-device memory that have been designated as device memory. With address space layout randomization, the pages are mapped to random virtual addresses on every boot so that attackers cannot easily target the pages with statically generated malware.

At 306, encrypted, authenticated, anti-replay protection is applied by the CPU to the page of non-device memory that has been designated as device memory (especially if the page is off-chip DRAM). This protection may be applied, for example, by a DRAM controller. And so, in examples where the sensitive data is to be stored off-chip in a DRAM (rather than using an on-chip SRAM), additional mitigations are employed.

At 308, address space un-mapping is applied by the CPU to the page of non-device memory that has been designated as device memory. With address space un-mapping, pages containing sensitive information are only mapped briefly when access is needed. Otherwise, those pages are un-mapped and hence cannot be easily accessed by malware or by speculative branches of privileged processes.

At 310, guard pages are applied by the CPU around the page of non-device memory that has been designated as device memory. With guard pages, pages containing sensitive information are bracketed in memory by pages that contain no information accessed by the processor. If an attack seeks to trick the processor into an overflow that spills from one page to the next, the attack would then not access any sensitive data.

It should be understood that the operations of blocks 304-310 may be applied, or not applied, separately. Moreover, the operations may be performed in a different order than as shown, or concurrently, or some of the operations may be performed concurrently along with others, while other operations are performed sequentially. Depending upon the particular mitigations, some should be performed before others. For example, address space layout randomization is usually applied when a computer is booted up, and hence this particular operation may be performed before all other listed mitigations and before any speculative processing begins. Those skilled in the art will understand when and how the various mitigations of FIG. 3 can be applied or implemented, and implementation details may vary from system to system and so such details are not described herein.

### Exemplary Software Interface-Based Systems and Procedures

In some examples, software interfaces are used to facilitate or perform the security features described above. Illustrative embodiments will now be described. In a first example, an operating system (OS), hypervisor or other supervisory system includes software or firmware that for security purposes maintains a pool of device-marked memory pages and advertises and makes available the pages through paged memory management mechanisms to supervised software (such as applications, virtual machine (VM) guests, etc.). Since the pages of memory are marked as “device,” the pages are thus “non-speculative” (e.g. unspeculatable) and sensitive information may be stored therein. In a second example, the operating system, hypervisor or other supervisory system includes software or firmware that maintains a region of device-marked non-speculative/unspeculatable memory, which the software or firmware makes available to supervised software via an application programming interface API (such as a keystore, password manager, data vault, etc.)

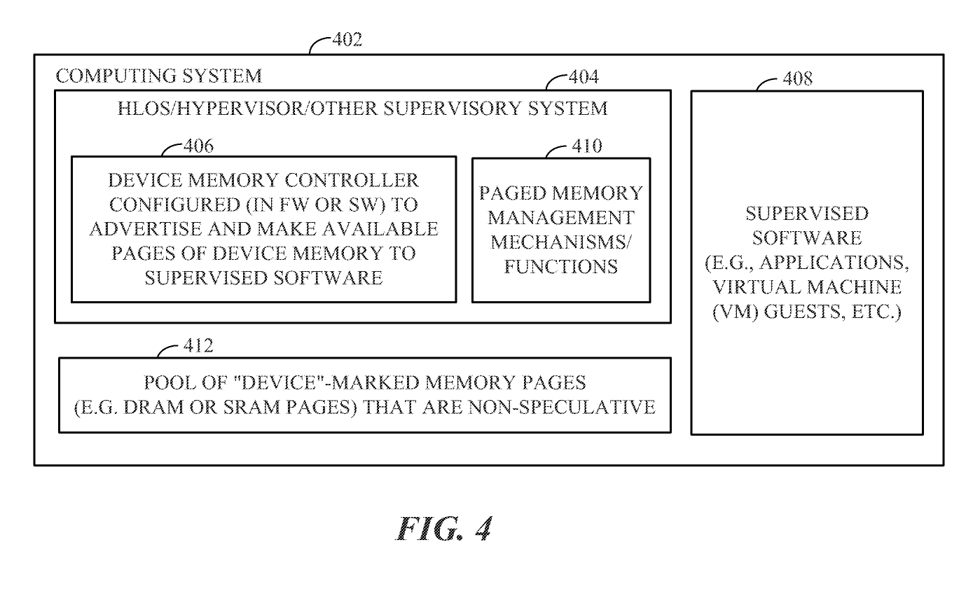

FIG. 4 illustrates, at a high level, computing system components of the first example. Briefly, a computing system 402 includes an HLOS, hypervisor or other supervisory system 404, which may have both software and firmware components. In the example of FIG. 4, the supervisory system 404 includes a device memory controller 406 configured (in firmware (FW) or software (SW)) to advertise (or otherwise expose) the pages of memory and make available pages of device memory to supervised software 408. The supervised software 408 may include, for example, applications, VM guests, etc. The device memory controller 406 advertises and makes the pages available by using paged memory management mechanisms/functions 410 of the supervisory system 404. The pages to be made available are stored or maintained as a pool 412 of device-marked memory pages (which are thus non-speculative/unspeculatable). The pool 412 of device-marked memory pages may be stored, for example, in DRAM or SRAM. As already described, by marking pages of otherwise non-device memory as device memory, speculative access to the pages is prevented to avoid exposing sensitive information stored therein to hackers or the like.

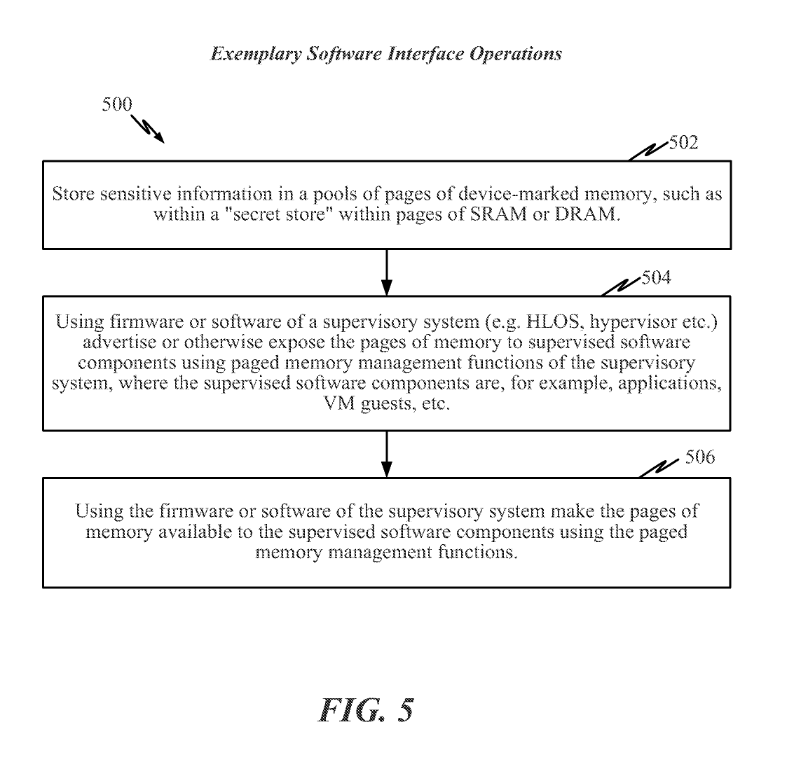

FIG. 5 summarizes, at a high level, operations 500 that may be performed by the system of FIG. 4 or other suitably-equipped systems. Briefly, at 502, sensitive information is stored within a secret store (as discussed above) within pools of pages of device-marked memory, such as SRAM or DRAM. At 504, using firmware of a supervisory system (e.g. HLOS, hypervisor etc.), the pages of memory are advertised or otherwise exposed to supervised software components using paged memory management functions of the supervisory system, where the supervised software components are, for example, applications, VM guests, etc. At 506, using the software or firmware of the supervisory system, the pages of memory are made available to the supervised software components using the paged memory management functions.

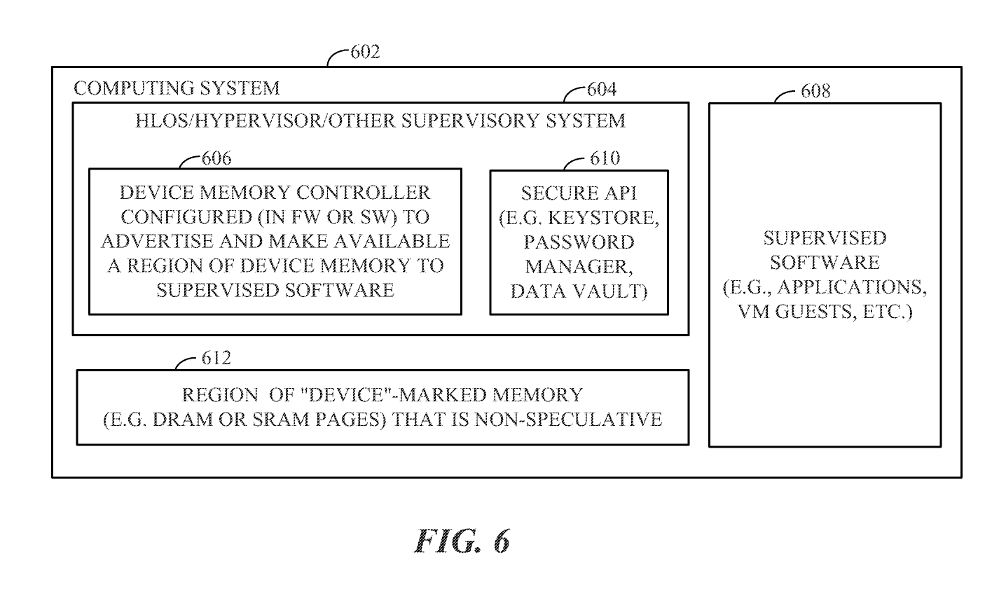

FIG. 6 illustrates, at a high level, the computing system components of the second example. Briefly, a computing system 602 again includes an HLOS, hypervisor or other supervisory system 604, which may have both software and firmware components. In the example of FIG. 6, the supervisory system 604 includes a device memory controller 606 (implemented in FW or SW) that is configured to advertise and make available regions of device memory to supervised software 608. The supervised software 608 again may include applications, VM guests, etc. However, in this example, the device memory controller 606 advertises (or otherwise exposes) and makes available one or more regions of memory by using a secure API 610 of the supervisory system 604. The secure API 610 may include a keystore, password manager, data vault, etc. An example of a keystore is the Java KeyStore, which is a repository of security certificates such as authorization certificates or public key certificates. (Java is a trademark of Sun Microsystems, Inc.). The region of memory to be made available may be stored or maintained as a device-marked memory region 612 (which is thus non-speculative/unspeculatable) in DRAM or SRAM. By marking a region of otherwise non-device memory as device memory, speculative access to the region of memory is prevented.

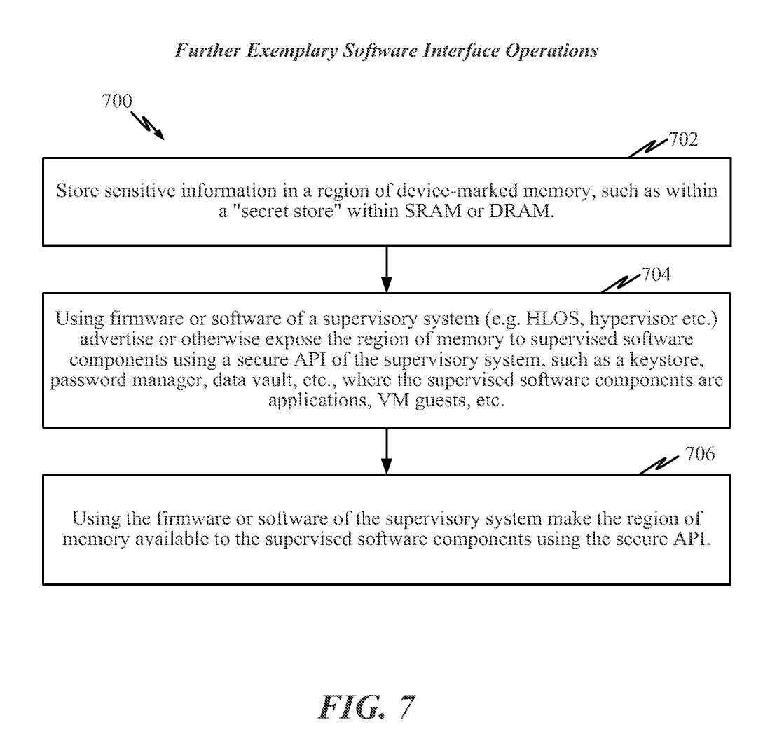

FIG. 7 summarizes, at a high level, operations 700 that may be performed by the system of FIG. 6 or other suitably-equipped systems. Briefly, at 702, sensitive information (such as passwords or the like) is stored within a secret store within a region of device-marked memory, such as a region of SRAM or DRAM. At 704, using software or firmware of a supervisory system (e.g. HLOS, hypervisor, etc.), the region of memory is advertised or otherwise exposed to supervised software components using a secure API of the supervisory system, where the supervised software components may again be applications, VM guests, etc., and where the secure API may be a keystore, password manager, data vault, etc. At 706, using the software or firmware of the supervisory system, the region of memory is made available to the supervised software components using the secure API.

### Exemplary Hardware Environments

Aspects of the systems and methods described herein can be exploited using a wide variety of computing systems and for a wide range of applications, including mobile devices, servers, etc. To provide a concrete example of a computing system, an exemplary system will now be described that uses a RISC-based CPU.

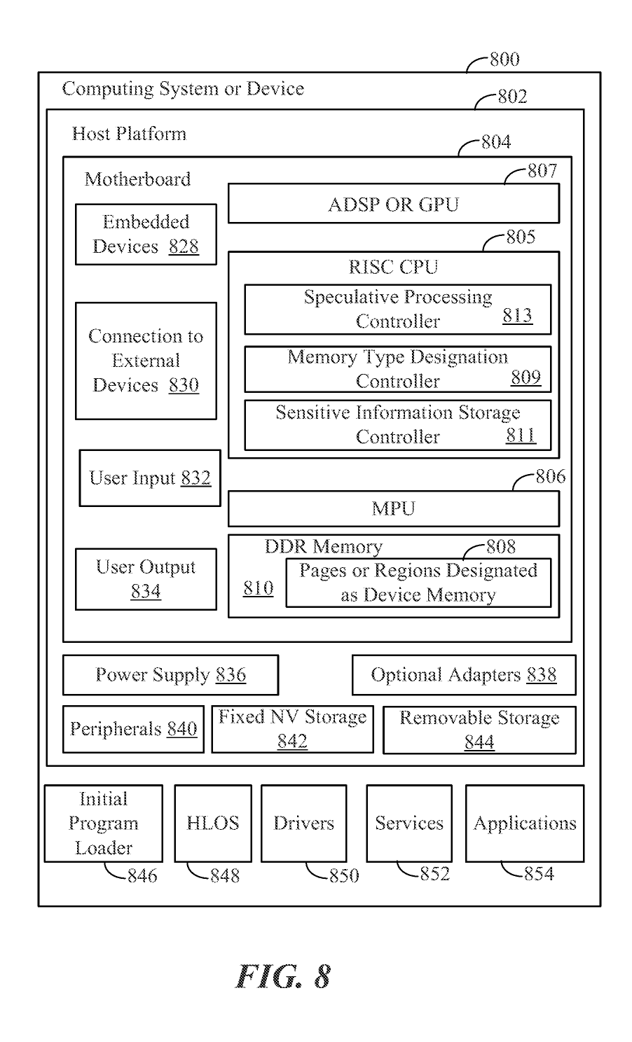

FIG. 8 illustrates selected components of a computing architecture incorporating components for designating portions of non-device memory as device memory, e.g. for marking non-device memory as device memory to prevent speculative processing from accessing sensitive information stored within those portions of memory.

Briefly, computing system or device 800 includes a host platform 802 provided with a motherboard 804 that includes, among various other components, a RISC CPU 805 and an application digital signal processor (ADSP) and/or graphics processing unit (GPU) 807. The RISC CPU 805 includes a memory type designation controller 809, a sensitive information storage controller 811, and a speculative processing controller 813. In this example, the memory type designation controller 809 operates to designate pages or regions 808 within a DDR memory 810 as device memory. The sensitive information storage controller 811 operates to store sensitive information within the pages or regions 808 of the DDR memory 810 that have been designated as device memory to prevent any speculative access to the sensitive information. Note that the CPU 805 and the ADSP 807, along with other components, may be implemented as a System-on-a-Chip (SoC), which may include other devices or components as well. An exemplary SoC is described below.

Various other exemplary components and features of system 800 are also shown in FIG. 8 for the sake of completeness. Briefly, in this example, the motherboard 804 includes various other embedded devices 828, connections 830 to external devices, and user input 832 and user output 834 components. The host platform includes a power supply 836, optional adapters 838, peripherals 840, fixed nonvolatile storage 842 and removable storage 844. The overall system 800 further includes an initial program loader 846, the high level operating system (HLOS) 848 (which typically runs on the RISC CPU 805), various drivers 850, various services 852 and various applications 854 (where the drivers, services and applications may run on the CPU 805 on other processing components of the overall systems). Those skilled in the art will recognize that modifications may need to be made, where appropriate, to some of these components to accommodate the features described herein that protect sensitive information.

As noted, features described herein may be implemented in devices incorporating a SoC. To provide a concrete example, an exemplary SoC hardware environment will now be described.

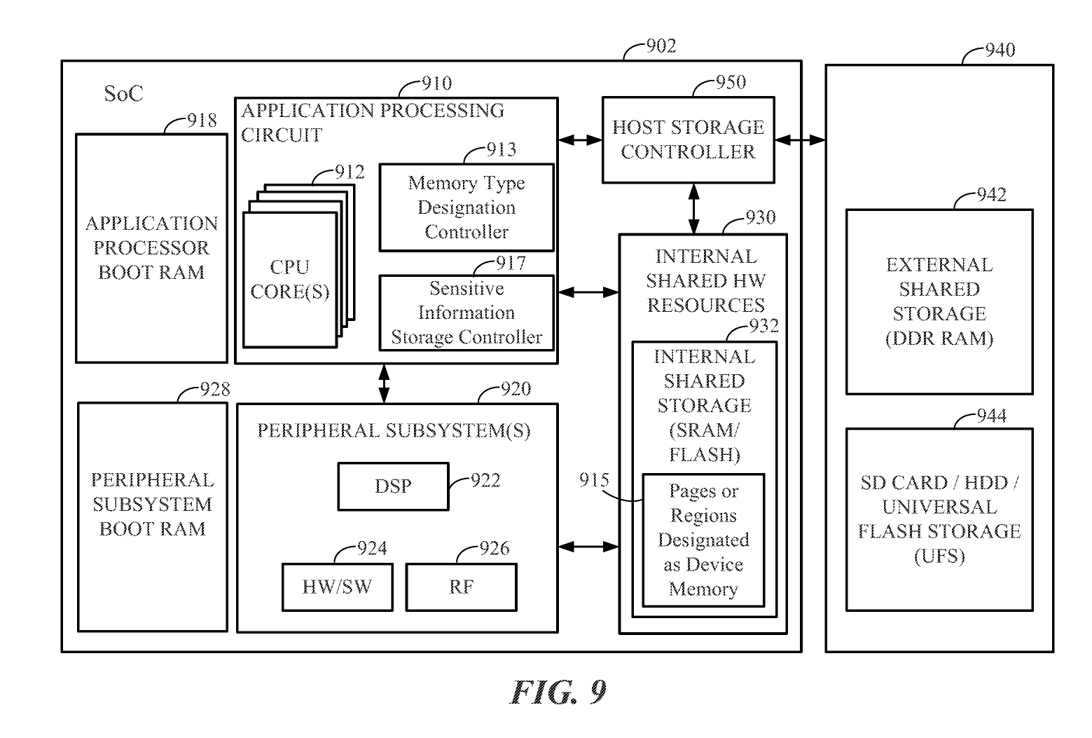

FIG. 9 illustrates selected components of a computing system 900 having a SoC processing circuit 902. The SoC processing circuit 902 may be a modified version of a Snapdragon™ processing circuit of Qualcomm Incorporated for use within a mobile device user equipment (UE) or in other devices or systems. The SoC processing circuit 902 includes an application processing circuit 910, which includes a multi-core CPU 912 equipped to operate in conjunction with a memory type designation controller 913, which, in this example, operates to designate pages or regions 915 with an internal shared storage device 930 as device memory. The application processing circuit 910 also includes a sensitive information storage controller 917 that operates to store sensitive information within the pages or regions 915 of the internal shared storage device 932 that have been designated as device memory to prevent any speculative access to the sensitive information. Although not shown in FIG. 9, speculative processing components or controllers may be provided within the application processing circuit 910, and in particular within the CPU core(s) 912. Still further, components for identifying sensitive information may be provided so that the information can be stored within the pages or regions 915 of the internal shared storage device 932 designated as device memory.

In the example of FIG. 9, the application processing circuit 910 is coupled to a host storage controller 950 for controlling storage of data in the internal shared storage device 932 that forms part of internal shared hardware (HW) resources 930. The application processing circuit 910 may also include a boot RAM or ROM 918 that stores boot sequence instructions for the various components of the SoC processing circuit 902. The SoC processing circuit 902 further includes one or more peripheral subsystems 920 controlled by application processing circuit 910. The peripheral subsystems 920 may include but are not limited to a storage subsystem (e.g., read-only memory (ROM), random access memory (RAM)), a video/graphics subsystem (e.g., digital signal processing circuit (DSP), graphics processing circuit unit (GPU)), an audio subsystem (e.g., DSP, analog-to-digital converter (ADC), digital-to-analog converter (DAC)), a power management subsystem, security subsystem (e.g., encryption components and digital rights management (DRM) components), an input/output (I/O) subsystem (e.g., keyboard, touchscreen) and wired and wireless connectivity subsystems (e.g., universal serial bus (USB), Global Positioning System (GPS), Wi-Fi, Global System Mobile (GSM), Code Division Multiple Access (CDMA), 4G Long Term Evolution (LTE) modems). The exemplary peripheral subsystem 920, which is a modem subsystem, includes a DSP 922, various other hardware (HW) and software (SW) components 924, and various radio-frequency (RF) components 926. In one aspect, each peripheral subsystem 920 also includes a boot RAM or ROM 928 that stores a primary boot image (not shown) of the associated peripheral subsystems 920. As noted, the SoC processing circuit 902 further includes various internal shared HW resources 930, such as the aforementioned internal shared storage 932 (e.g. static RAM (SRAM), flash memory, etc.), which is shared by the application processing circuit 910 and the various peripheral subsystems 920 to store various runtime data or other parameters and to provide host memory and which may store various keys or passwords for secure processing.

In one aspect, the components 910, 918, 920, 928, 930 and 950 of the SoC 902 are integrated on a single-chip substrate. The system further includes various external shared HW resources 940, which may be located on a different chip substrate and may communicate with the SoC 902 via one or more buses. External shared HW resources 940 may include, for example, an external shared storage 942 (e.g. double-data rate (DDR) dynamic RAM) and/or permanent or semi-permanent data storage 944 (e.g., a secure digital (SD) card, hard disk drive (HDD), an embedded multimedia card, a universal flash device (UFS), etc.), which may be shared by the application processing circuit 910 and the various peripheral subsystems 920 to store various types of data, such as an operating system (OS) information, system files, programs, applications, user data, audio/video files, etc. When a device incorporating the SoC 902 is activated, the SoC 902 begins a system boot up process in which the application processing circuit 910 may access boot RAM or ROM 918 to retrieve boot instructions for the SoC processing circuit 902, including boot sequence instructions for the various peripheral subsystems 920. The peripheral subsystems 920 may also have additional peripheral boot RAM or ROM 928. As already explained, in some examples, sensitive data may be stored off chip, such as in DDR RAM 942, within portions of memory therein designated or marked as “device memory” and with suitable additional protections, such as encryption.

### Further Exemplary Embodiments and Environments

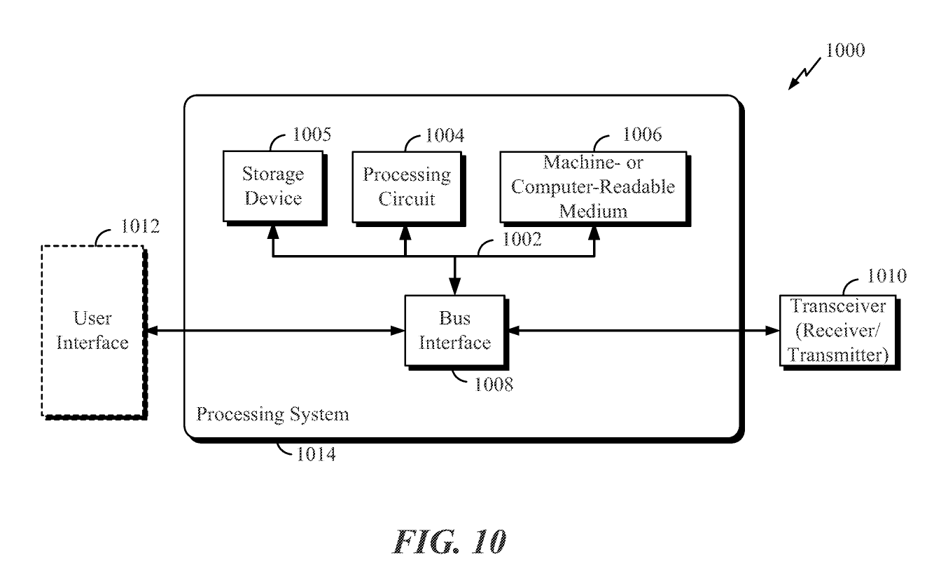

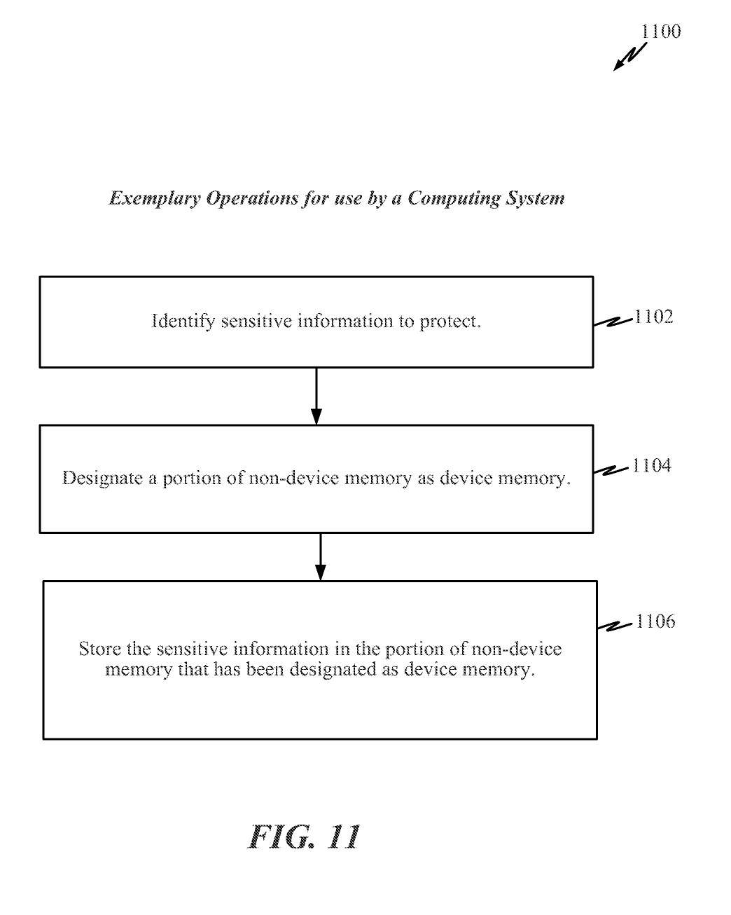

FIG. 10 illustrates an overall system or apparatus 1000 in which the systems, methods and apparatus of FIGS. 1-9 (and FIGS. 11-14, discussed below) may be implemented. In accordance with various aspects of the disclosure, an element, or any portion of an element, or any combination of elements may be implemented with a processing system 1014 that includes one or more processing circuits 1004, such as the SoC of FIG. 9. Depending upon the device, apparatus 1000 may be used with a radio network controller (RNC).

In the example of FIG. 10, the processing system 1014 may be implemented with a bus architecture, represented generally by bus 1002. The bus 1002 may include any number of interconnecting buses and bridges depending on the specific application of the processing system 1014 and the overall design constraints. The bus 1002 links various circuits including one or more processing circuits (represented generally by the processing circuit 1004), the storage device 1005, and a machine-readable, processor-readable, processing circuit-readable or computer-readable media (represented generally by a non-transitory machine-readable medium 1006). The bus 1002 may also link various other circuits such as timing sources, peripherals, voltage regulators, and power management circuits, which are well known in the art, and therefore, will not be described any further. The bus interface 1008 provides an interface between bus 1002 and a transceiver 1010. The transceiver 1010 provides a means for communicating with various other apparatus over a transmission medium. Depending upon the nature of the apparatus, a user interface 1012 (e.g., keypad, display, speaker, microphone, joystick) may also be provided but is not required.

The processing circuit 1004 is responsible for managing the bus 1002 and for general processing, including the execution of software stored on the machine-readable medium 1006. The software, when executed by processing circuit 1004, causes processing system 1014 to perform the various functions described herein for any particular apparatus. Machine-readable medium 1006 may also be used for storing data that is manipulated by processing circuit 1004 when executing software.

One or more processing circuits 1004 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 1006. The machine-readable medium 1006 may be a non-transitory machine-readable medium or computer-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 1006 may reside in the processing system 1014, external to the processing system 1014, or distributed across multiple entities including the processing system 1014. The machine-readable medium 1006 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

The various illustrative logical blocks, modules, circuits, elements, and/or components described in connection with the examples disclosed herein may be implemented or performed with a general purpose processing circuit, a DSP, an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

Hence, in one aspect of the disclosure, processing circuit 1004 illustrated in FIG. 10—or components thereof—may be a specialized processing circuit (e.g., an ASIC)) that is specifically designed and/or hard-wired to perform the algorithms, methods, and/or blocks described in FIGS. 1, 2, 3, 4, 5, 6, 7, 8, and 9 (and in FIGS. 11, 12, 13, and 14, discussed below). Thus, such a specialized processing circuit (e.g., ASIC) may be one example of a means for executing the algorithms, methods, and/or blocks described in FIGS. 1, 2, 3, 4, 5, 6, 7, 8, and 9 (and in FIGS. 11, 12, 13, and 14, discussed below). The machine-readable storage medium may store instructions that when executed by a specialized processing circuit (e.g., ASIC) cause the specialized processing circuit to perform the algorithms, methods, and/or blocks described herein.

FIG. 11 illustrates an exemplary method 1100 that may be provided for use by a computing system or processor equipped to access device memory and non-device that includes: identifying, at 1102, sensitive information to protect; designating, at 1104, a portion of non-device memory (e.g. “speculative” or “speculatable” memory) as device memory (e.g. “non-speculative” or “unspeculatable” memory); and storing, at 1106, the sensitive information in the portion of non-device memory that has been designated as device memory to, for example, prevent speculative access to the sensitive information by a speculative processor of the computing system to reduce the vulnerability of the sensitive information to a malicious attack. Identifying the sensitive information to protect may be performed, in some examples, during a design phase where system designers identify the sensitive data.

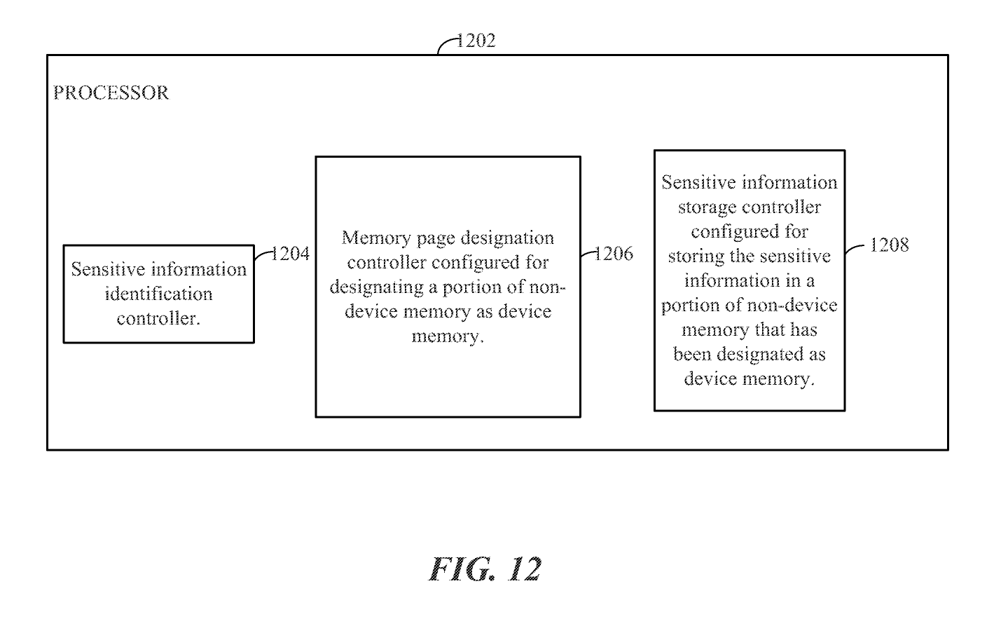

FIG. 12 illustrates components of an exemplary processing system or processor 1200. Briefly, the processor of FIG. 12 includes a sensitive information identification controller 1204 configured to identify sensitive information to protect. A memory page designation controller 1206 is configured for designating a portion of the non-device memory (e.g. the speculative access memory/speculatable memory) as device memory (e.g. as non-speculative access memory/unspeculatable memory). A sensitive information storage controller 1208 is configured for storing the sensitive information in the portion of non-device memory that has been designated as (unspeculatable memory) device memory. As already explained, this may be performed to prevent speculative access to sensitive information to reduce the vulnerability of the sensitive information to a malicious attack. Component 1204 is one example of a means for identifying sensitive information to protect. Component 1206 is one example of a means for designating a portion of non-device memory as device memory. Component 1208 is one example of a means for storing the sensitive information in the portion of non-device memory that has been designated as device memory.

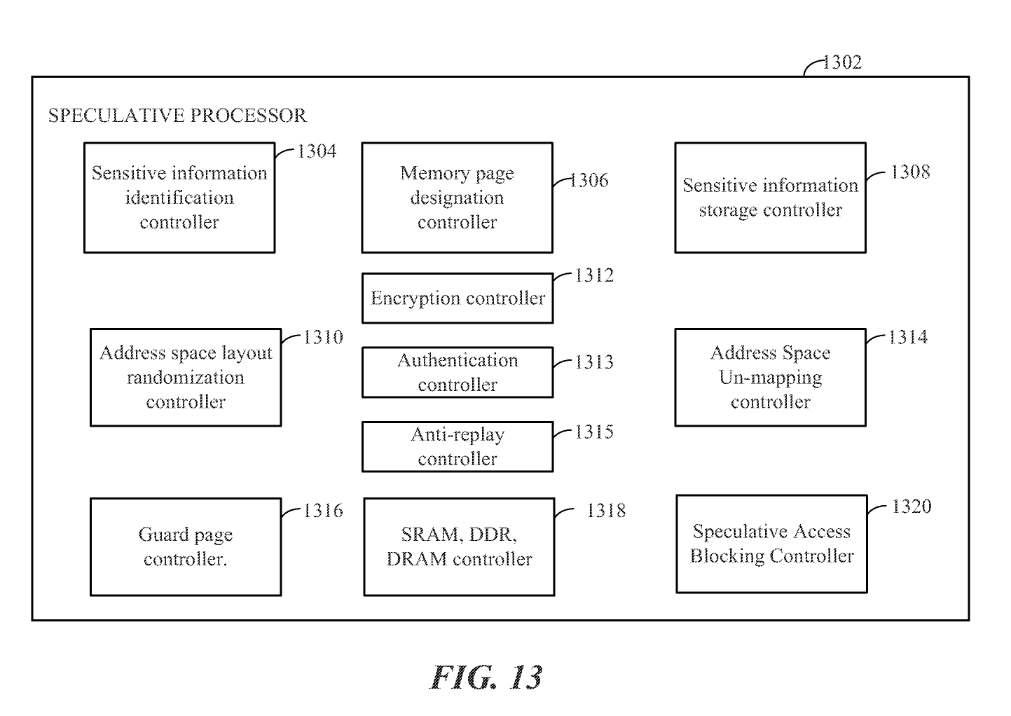

FIG. 13 illustrates additional components of an exemplary processor 1302, where processor 1302 is a speculative processor. As with the processor of FIG. 12, the processor of FIG. 13 includes a sensitive information identification controller 1304 configured to identify sensitive information to protect, a memory page designation controller 1306 configured to designate a portion of the non-device memory as device memory, and a sensitive information storage controller 1308 configured to store the sensitive information in the portion of non-device memory designated as device memory.

Additionally, the processor 1302 of FIG. 13 includes: an address space layout randomization controller 1310 configured to apply address space layout randomization to the portion of non-device memory designated as device memory; an encryption controller 1312 configured to encrypt the portion of non-device memory designated as device memory; an authentication controller 1313 configured to authenticate the portion of non-device memory designated as device memory; an anti-replay controller 1315 configured to apply anti-replay-protection to the portion of non-device memory designated as device memory; an un-mapping controller 1314 configured to apply address space un-mapping to the portion of non-device memory designated as device memory; a guard-page controller 1316 configured to apply guard pages to the portion of non-device memory designated as device memory; an SRAM, DDR, DRAM controller 1318 for controlling access to one or more of SRAM, DDR or DRAM or other memory devices; and a speculative access blocking controller 1320 configured to block the components from speculatively accessing device during speculative execution of code. Note that, although shown as components of the processor, many of the components on FIG. 13 may be instead implemented as operating system/software entities/techniques.

It should be understood that the components of FIG. 13 may be implemented, or not implemented, separately. For instance, the speculative processor 1302 might include components 1304 and 1310, but not components 1306 and 1308. In other examples, the speculative processor might be include components 1306 and 1308, but not components 1304 and 1316, and so on. The operations of various the components may be performed concurrently or sequentially, or some of the operations may be performed concurrently along with others, while operations of other of the components may be performed sequentially. The functions or operations of particular components may be combined or separated. For example, a single component may be provided for encryption and authentication.

In at least some examples, means may be provided for performing the functions illustrated in FIG. 13 and/or other functions illustrated or described herein. For example, an apparatus (e.g. processor 1302) may be provided where the apparatus includes: means (e.g. component 1304) for identifying sensitive information to protect; means (e.g. component 1306) for designating a portion of the non-device memory as device memory; and means (e.g. component 1308) for storing the sensitive information in the portion of non-device memory designated as device memory. The apparatus may also include means (e.g. component 1310) for applying address space layout randomization to the portion of non-device memory designated as device memory; means (e.g. component 1312) for encrypting the portion of non-device memory designated as device memory; means (e.g. component 1313) for authenticating the portion of non-device memory designated as device memory; means (e.g. component 1315) for applying anti-replay-protection to the portion of non-device memory designated as device memory; means (e.g. component 1314) for applying address space un-mapping to the portion of non-device memory designated as device memory; means (e.g. component 1316) for applying guard pages to the portion of non-device memory designated as device memory; means (e.g. component 1318) for controlling access to one or more of SRAM, DDR or DRAM or other memory devices; and means (e.g. component 1320) for blocking the components from speculatively accessing device during speculative execution of code. These are just some exemplary means plus function components.

In at least some examples, a machine-readable storage medium may be provided having one or more instructions which when executed by a processing circuit causes the processing circuit to performing the functions illustrated in FIG. 13 and/or other functions illustrated or described herein. For example, instructions may be provided for: identifying sensitive information to protect; designating a portion of the non-device memory as device memory; and storing the sensitive information in the portion of non-device memory designated as device memory. The instructions may also include instructions for applying address space layout randomization to the portion of non-device memory designated as device memory; instructions for encrypting the portion of non-device memory designated as device memory; instructions for authenticating the portion of non-device memory designated as device memory; instructions for applying anti-replay-protection to the portion of non-device memory designated as device memory; instructions for applying address space un-mapping to the portion of non-device memory designated as device memory; instructions for applying guard pages to the portion of non-device memory designated as device memory; instructions for controlling access to one or more of SRAM, DDR or DRAM or other memory devices; and instructions for blocking the components from speculatively accessing device during speculative execution of code. These are just some exemplary instructions.

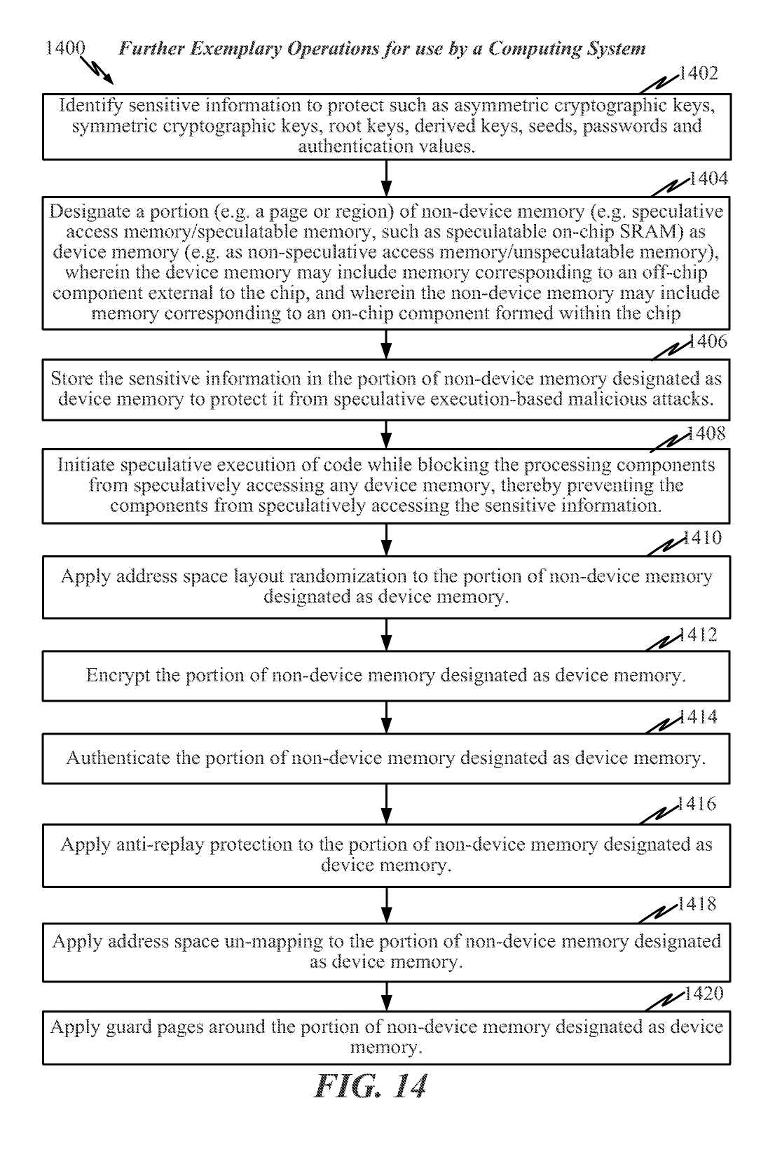

FIG. 14 illustrates additional or alterative operations or procedures 1400 that may be implemented by a computing system or processor equipped to access device memory and non-device. Briefly, at 1402, the processor identifies sensitive information to protect such as asymmetric cryptographic keys, symmetric cryptographic keys, root keys, derived keys, seeds, passwords and authentication values. At 1404, the processor designates a portion (e.g. a page or region) of non-device memory (e.g. speculative access memory/speculatable memory, such as speculatable on-chip SRAM) as device memory (e.g. as non-speculative access memory/unspeculatable memory), wherein the device memory may include, in some examples, memory corresponding to an off-chip component external to the chip, and wherein the non-device memory may include, in some examples, memory corresponding to an on-chip component formed within the chip. At 1406, the processor stores or saves the sensitive information in the portion of (normally speculatable) non-device memory designated as (unspeculatable) device memory to protect it from speculative execution-based malicious attacks. At 1408, the processor initiates speculative execution of code while blocking the processing components from speculatively accessing any (unspeculatable) device memory, thereby preventing the components from speculatively accessing the sensitive information. At 1410, the processor applies address space layout randomization to the portion of non-device memory designated as device memory. At 1412, the processor encrypts the portion of non-device memory designated as device memory. At 1414, the processor authenticates the portion of non-device memory designated as device memory. At 1416, the processor applies anti-replay protection to the portion of non-device memory designated as device memory. At 1418, the processor applies address space un-mapping to the portion of non-device memory designated as device memory. At 1420, the processor applies guard pages around the portion of non-device memory designated as device memory.

It should be understood that the operations of blocks 1408-1420 may be applied, or not applied, separately. Moreover, the operations may be performed in a different order than as shown, or concurrently, or some of the operations may be performed concurrently along with others, while other operations are performed sequentially. As noted above, address space layout randomization is applied when a computer is booted up, and hence address space layout randomization may be performed first, before all other operations in FIGS. 14. Those skilled in the art will understand how and when the various mitigations of FIG. 14 can be applied or implemented, and so these details are not described herein.

Note that, herein, the terms “obtain” or “obtaining” broadly cover, e.g., calculating, computing, generating, acquiring, receiving, retrieving, inputting or performing any other suitable corresponding actions. Note also that aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

Moreover, in the following description and claims the terms “coupled” and “connected,” along with their derivatives, may be used. It should be understood that these terms are not intended as synonyms for each other. Rather, in particular aspects, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

Not all components, features, structures, characteristics, etc. described and illustrated herein need be included in a particular aspect or aspects. If the specification states a component, feature, structure, or characteristic “may,” “might,” “can” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In each figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

It is to be noted that, although some aspects have been described in reference to particular implementations, other implementations are possible according to some aspects. Additionally, the arrangement and/or order of circuit elements or other features illustrated in the drawings and/or described herein need not be arranged as illustrated and described. Many other arrangements are possible according to some aspects.

What is claimed is:

1. A method for use by a computing system equipped to access device memory and non-device memory, the method comprising:
identifying sensitive information to protect;
designating a portion of non-device memory as device memory; and
storing the sensitive information in the portion of non-device memory designated as device memory.

2. The method of claim 1, wherein memory designated as device memory is unspeculatable memory and wherein memory designated as non-device memory is speculatable memory.

3. The method of claim 1, wherein the computing system includes components configured to perform speculative processing, and wherein the method includes blocking the components from speculatively accessing any device memory, thereby preventing the components from speculatively accessing the sensitive information.

4. The method of claim 1, further comprising applying address space layout randomization to the portion of non-device memory designated as device memory.

5. The method of claim 1, further comprising applying anti-replay-protection to the portion of non-device memory designated as device memory.

6. The method of claim 1, wherein the method further includes encrypting the portion of non-device memory designated as device memory.

7. The method of claim 1, further comprising authenticating the portion of non-device memory designated as device memory.

8. The method of claim 1, further comprising applying address space un-mapping to the portion of non-device memory designated as device memory.

9. The method of claim 1, further comprising applying guard pages to the portion of non-device memory designated as device memory.

10. The method of claim 1, wherein the sensitive information comprises one or more of asymmetric cryptographic keys, symmetric cryptographic keys, root keys, derived keys, seeds, passwords and authentication values.

11. The method of claim 1, wherein the portion of non-device memory designated as device memory includes pages of memory, and wherein the method includes making the pages of memory available to supervised software using paged memory management functions of a supervisory system of the computing system.

12. The method of claim 11, wherein method further includes advertising or exposing the pages of memory to the supervised software using the paged memory management functions of the supervisory system of the computing system.

13. The method of claim 1, wherein the portion of non-device memory includes a region of memory, and wherein the method includes making the region of memory available to supervised software using a secure application programming interface (API) of a supervisory system of the computing system.

14. A computing system, comprising:
a memory including a portion that is non-device memory; and
a processor configured to
identify sensitive information to protect;
designate a portion of the non-device memory as device memory; and
store the sensitive information in the portion of non-device memory designated as device memory.

15. The computing system of claim 14, wherein device memory is unspeculatable memory and non-device memory is speculatable memory.

16. The computing system of claim 14, wherein the computing system includes components configured for speculative processing, and wherein the processor is further configured to block the components from speculatively accessing device memory, thereby preventing the components from speculatively accessing the sensitive information.

17. The computing system of claim 14, wherein the processor is further configured to apply address space layout randomization to the portion of non-device memory designated as device memory.

18. The computing system of claim 14, wherein the processor is further configured to apply anti-replay-protection to the portion of non-device memory designated as device memory.

19. The computing system of claim 14, wherein the computing system is further configured to encrypt and/or authenticate the portion of non-device memory designated as device memory.

20. The computing system of claim 14, wherein the processor is further configured to apply address space un-mapping to the portion of non-device memory designated as device memory.

21. The computing system of claim 14, wherein the processor is further configured to apply guard pages to the portion of non-device memory designated as device memory.

22. The computing system of claim 14, wherein the portion of non-device memory designated as device memory is dynamic random access memory (DRAM) or static random access memory (SRAM).

23. The computing system of claim 14, wherein the computing system includes a system-on-a-chip (SoC), and wherein the portion of non-device memory designated as device memory is static random access memory (SRAM) within the SoC.

24. The computing system of claim 14, wherein the computing system includes a system-on-a-chip (SoC), and wherein the portion of non-device memory designated as device memory is separate from the SoC.

25. The computing system of claim 14, wherein the sensitive information comprises one or more of asymmetric cryptographic keys, symmetric cryptographic keys, root keys, derived keys, seeds, passwords and authentication values.

26. The computing system of claim 14, wherein the portion of non-device memory designated as device memory includes pages of memory, and wherein the processor is further configured to make the pages of memory available to supervised software using paged memory management functions of a supervisory system of the computing system.

27. The computing system of claim 26, wherein the processor is further configured to advertise or expose the pages of memory to the supervised software using the paged memory management functions of the supervisory system of the computing system.

28. The computing system of claim 14, wherein the portion of non-device memory includes a region of memory, and wherein the processor is further configured to make the region of memory available to supervised software using a secure application programming interface (API) of a supervisory system of the computing system.

29. An apparatus comprising:
means for identifying sensitive information to protect;
means for designating a portion of non-device memory as device memory; and
means for storing the sensitive information in the portion of non-device memory designated as device memory.

30. A non-transitory machine-readable storage medium for use with a computing system, the machine-readable storage medium having one or more instructions which when executed by at least one processing circuit of the computing system causes the at least one processing circuit to:
identify sensitive information to protect;
designate a portion of non-device memory as device memory; and
store the sensitive information in the portion of non-device memory designated as device memory.
